(19) United States
(12) Patent Application Publication
(10) Pub. No.: US 2026/0252986 A1
(43) Pub. Date: Aug. 27, 2026

(54) INFORMATION PROCESSING APPARATUS, INFORMATION PROCESSING METHOD, AND INFORMATION PROCESSING PROGRAM

(71) Applicant: NTT, Inc., Tokyo (JP)

(72) Inventors: Yuya HIKIMA, Musashino-shi (JP); Taichi ASAMI, Musashino-shi (JP); Hideaki KIN, Musashino-shi (JP); Yasunori AKAGI, Musashino-shi (JP)

(73) Assignee: NTT, Inc., Tokyo (JP)

(21) Appl. No.: 18/870,479

(22) PCT Filed: Jun. 13, 2022
(86) PCT No.: PCT/JP2022/023634

§ 371 Date: Nov. 29, 2024

(51) Int. Cl. G06Q 10/0631; G06Q 10/04

(52) U.S. Cl. CPC G06Q 10/06315; G06Q 10/04

(57) ABSTRACT

An information processing apparatus includes: a setting part which defines a problem by formulating optimization of resource options and prices of the options presented to each user in a market in which a plurality of types of limited resources are handled; and an action determination part which determines the resource options and the prices of the options to be presented to each of the users by solving the problem.

### TECHNICAL FIELD

Embodiments of the present invention relate to an information processing apparatus, an information processing method, and an information processing program.

### BACKGROUND ART

In the market for a plurality of types of limited resources, there are various services such as taxi platforms which use taxis as resources and cloud computing that uses CPUs as resources. In such markets, market providers need to present (a) options and (b) prices regarding resources to customers who appear in services via online or the like. For example, when a customer appears on a taxi platform and requests transportation from their current location to their destination location through a ride-hailing service, it is necessary to show the customer (a) which area's taxis to choose from and (b) the price of each option. At this time, the company's profits will fluctuate in accordance with the options and prices in (a) and (b).

First, with regard to (a), if a user continues to present the same options to a plurality of customers, the user will run out of resources and the number of options which can be presented to customers will decrease. On the other hand, if an attempt is made to present only convenient options to customers in terms of resources, the number of customers who are presented with undesirable options increases. These problems reduce the company's profits by making it impossible to provide appropriate services to customers in terms of resources, or by causing customers to stop using the services. Subsequently, with regard to (b), if a user sets a price which is too low for a resource which is in high demand, customers will choose only that resource and the resource will run out, reducing the number of options available to customers. On the other hand, if a user places a too high price on a particular resource, the user ends up with a surplus of that resource. Similarly, this also reduces corporate profits.

There is a technique which maximizes a company's profits by optimizing the assortment and prices of a plurality of products in the market (refer to, for example, NPL 1). However, although the technique disclosed in NPL 1 can be applied to retail businesses or the like in which the amount of products can be controlled using the amount of production, it does not take into account the finiteness of resources. Thus, it cannot be used for services in which the number of resources cannot be changed in the short term (for example, a taxi platform which allocates a limited number of taxis to customers or cloud computing that rents out a limited number of servers to customers).

Furthermore, there is a technique for optimizing the price of limited resources to maximize a company's profits while ensuring that demand does not exceed the amount of resources at a certain time (refer to, for example, NPL 2). However, although the technique disclosed in NPL 2 can be applied to the electricity and gas markets in which resources do not have different characteristics, it cannot be applied to markets in which a plurality of products exist and resources have different characteristics (for example, near, far, and the like) for each customer.

### CITATION LIST

### Non Patent Literature

[NPL 1] Ali Aouad, Vivek Farias, and Retsef Levi. Assortment optimization under consider-then-choose choice models. Management Science, Vol. 67, No. 6, pp. 3368-3386, 2021.
[NPL 2] Christian Borgs, Ozan Candogan, Jennifer Chayes, Ilan Lobel, and Hamid Nazerzadeh. Optimal multiperiod pricing with service guarantees. Management Science, Vol. 60, No. 7, pp. 1792-1811, 2014.

### SUMMARY OF INVENTION

### Technical Problem

The present invention was made focusing on the above circumstances, and an aspect of the present invention is to provide a technique for optimizing resource options and prices presented to each customer in a market which handles a plurality of types of limited resources.

### Solution to Problem

In order to achieve the above issues, an aspect of an information processing apparatus of the present invention includes: a setting part which defines a problem by formulating optimization of resource options and prices of the options presented to each user in a market in which a plurality of types of limited resources are handled; and an action determination part which determines the resource options and the prices of the options to be presented to each of the users by solving the problem.

### Advantageous Effects of Invention

According to an aspect of the present invention, it is possible to optimize resource options and prices presented to each customer.

### BRIEF DESCRIPTION OF DRAWINGS

FIG. 1 is a block diagram showing an example of a configuration of a server according to an embodiment.

FIG. 2 is a diagram schematically showing contents of information processing performed using the server according to the embodiment.

FIG. 3 is a flowchart for describing a processing procedure and processing contents of information processing performed using the server according to the embodiment.

FIG. 4 is a diagram schematically showing an example of processing contents of information processing performed using the server according to the embodiment.

### DESCRIPTION OF EMBODIMENTS

Embodiments of the present invention will be described below with reference to the drawings.

### EMBODIMENT

### Configuration Example

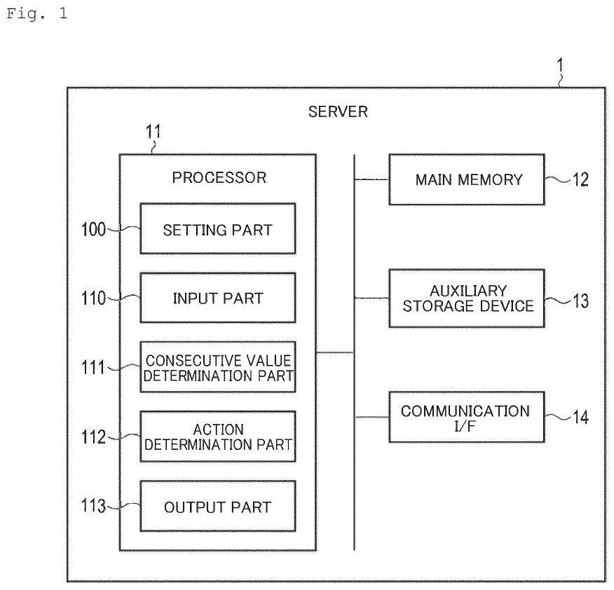

FIG. 1 is a block diagram showing an example of a configuration of a server 1 according to an embodiment. The server 1 is an electronic device which collects data and processes the collected data. The electronic device includes a computer.

The server 1 is an electronic device including a processor 11, a main memory 12, an auxiliary storage device 13, and a communication interface 14. Parts constituting the server 1 are connected to each other so that signals can be input and output. In FIG. 1, an interface is described as “I/F.”

The processor 11 corresponds to a central part of the server 1. The processor 11 is a component of the computer of the server 1. For example, the processor 11 is a central processing unit (CPU), but is not limited thereto. The processor 11 may be composed of various circuits. The processor 11 loads a program stored in the main memory 12 or the auxiliary storage device 13 in advance into the main memory 12. The program is a program which causes the processor 11 of the server 1 to realize or perform parts which will be described below. The processor 11 performs various operations by performing programs loaded in the main memory 12.

The main memory 12 corresponds to the main memory portion of the server 1. The main memory 12 is a component of the computer of the server 1. The main memory 12 includes a non-volatile memory region and a volatile memory region. The main memory 12 is a non-volatile memory region which stores an operating system or programs. The main memory 12 uses a volatile memory region as a work region in which data is rewritten as appropriate using the processor 11. For example, the main memory 12 includes a read only memory (ROM) as a non-volatile memory region. For example, the main memory 12 includes a random access memory (RAM) as a volatile memory area. The main memory 12 stores programs.

The auxiliary storage device 13 corresponds to the auxiliary storage portion of the server 1. The auxiliary storage device 13 is a component of the computer of the server 1. The auxiliary storage device 13 is an electric erasable programmable read-only memory (EEPROM; registered trademark), a hard disc drive (HDD), a solid state drive (SSD), or the like. The auxiliary storage device 13 stores the above-described programs, data used by the processor 11 to perform various processes, and data generated using the processing in the processor 11. The auxiliary storage device 13 stores the above-described program.

The communication interface 14 includes various interfaces which communicatively connect the server 1 to other electronic devices via a network in accordance with a predetermined communication protocol.

Note that the hardware configuration of the server 1 is not limited to the above-described configuration. The server 1 allows the above-described components to be omitted and changed and new components to be added as appropriate.

Each of the parts implemented in the above-described processor 11 is explained.

The processor 11 implements a setting part 100, an input part 110, a consecutive value determination part 111, an action determination part 112, and an output part 113. Each of the parts implemented in the processor 11 can also be called each function. It can also be said that each of the parts implemented in the processor 11 is implemented in a control part including the processor 11 and the main memory 12.

The setting part 100 defines a problem by formulating optimization of resource options and prices of the options presented to each user in a market which handles a plurality of types of limited resources. A resource includes products or services distributed in the market. The resource is, for example, a taxi in a taxi market which provides a service of dispatching taxis to customers. A customer may be read as a user or a person. In this case, the resource options include, for example, taxis located in different areas. The resource options are, for example, a taxi in Area 1, a taxi in Area 2, a taxi in Area 3, and the like. The price of the option is, for example, the price of the resource that is the option. The price of the option is, for example, the initial fare of a taxi. Optimization of resource options and option prices includes, for example, providing resource options and option prices which maximize the reward for the resource provider. The problem defined using the setting part 100 is, for example, maximizing the reward of the resource provider. The resource provider is, for example, a company. The resource provider is, for example, a taxi company. The problem maximizes the total reward by repeatedly performing a process of observing users who appear from a set of a plurality users on the basis of a probability distribution, a process of presenting a plurality of options included in a plurality of resources and the prices of the plurality of options to the appearing user, a process of obtaining rewards for resource providers when one option is selected from a plurality of options depending on the probability distribution, a process of reducing the remaining amount of resources of one selected option by 1, and a process of changing the remaining amount of resources for each option depending on a value which follows the probability distribution multiple times.

The input part 110 receives, as inputs, a state based on a vector representing the user who has appeared, a vector representing the remaining amount of each resource, and a vector representing the current number of repetitions. The number of repetitions is the number of times the setting part 100 repeatedly performs the process. The current number of repetitions is the number of times the process has been repeatedly performed using the setting part 100 up to the present time.

The consecutive value determination part 111 uses mapping from the state to determine consecutive values of options and prices.

The action determination part 112 determines the resource options and the prices of the options to be presented to each user by solving the problem defined using the setting part 100. The action determination part 112 determines the resource options and the prices of the options to be presented to each user through reinforcement learning for the problem. The action determination part 112 determines one option as one action on the basis of the consecutive value determined using the consecutive value determination part 111. The action is, for example, the optimal option included in a plurality of resource options. The optimal option is, for example, the option which maximizes the reward among multiple resource options. The action indicates, for example, each combination of options and prices of each option to be presented to each user. The action determination part 112 determines one action for the consecutive value using mapping from a set of a predetermined number of neighbors in the discrete portion of the action space. The action space represents the entire set of possible actions. The action space is a set of combinations of vectors composed of discrete variables representing which options to present and vectors composed of continuous variables representing the price of each option.

The output part 113 outputs the action determined using the action determination part 112. In the following description, “output” may be replaced with “transmission”.

### (Example of Server Information Processing)

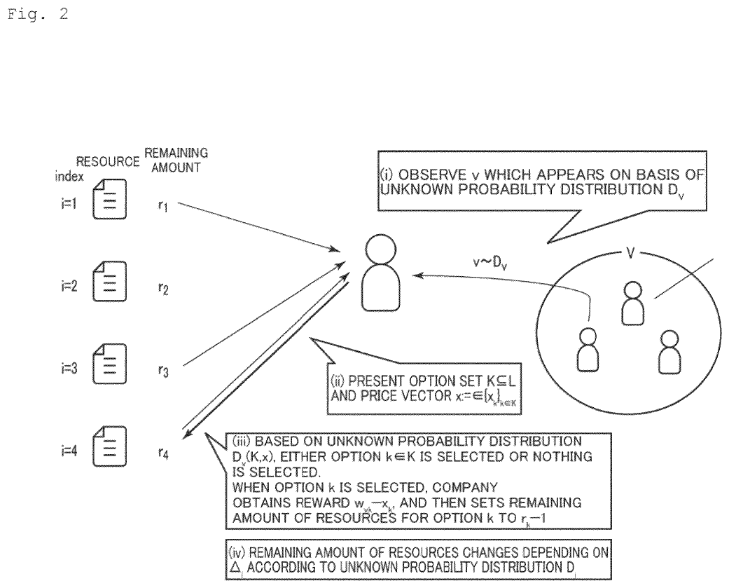

FIG. 2 is a diagram schematically showing the contents of information processing performed using the server 1 according to the embodiment.

FIG. 2 shows the series of processes which occur after a customer appears in the target market. A remaining amount ri is defined for each resource i=1, 2, . . . , m. In (i), a certain customer v appears from a set V of customer groups according to an unknown probability distribution D_{V}. In (ii), for the customers who appear, the option set K⊆L and the price vector

$$x := {\{ {x}_{k} \}}_{k ∈ K} \qquad [ Equation 1 ]$$

is presented. Here, L is all the options, and X:=[l, u]. In (iii), depending on the unknown probability distribution

$${D}_{v} ( K , x ) \qquad [ Equation 2 ]$$

either a certain option k∈K is selected or nothing is selected. When a certain option k∈K is selected, the company receives the reward

$${w}_{ν k} - {x}_{k} \qquad [ Equation 3 ]$$

as a reward and reduces the remaining amount of resources rk by 1. In (iv), for each resource i=1, 2 . . . , m, the remaining amount of the resource is increased by Δᵢ which occurred in accordance with the unknown probability distribution Dᵢ.

This series of steps is explained using the example of the taxi platform market.

It is assumed that V:={orderer departing from Area 1, orderer departing from Area 2, orderer departing from Area 3}. (i) represents a situation in which an orderer departs from a certain area appears. L={taxi in Area 1, taxi in Area 2, taxi in Area 3} is defined. In (ii), the processor 11 determines in which area the taxi service provider presents taxis as options to the customer and the fare of each taxi in the options. Here, the upper and lower limits of the fee are specified using u and 1, respectively. (iii) represents a situation in which the customer chooses one of the taxis from the options or chooses none at all. Based on the taxi selected by the customer, the processor 11 obtains the taxi service provider's remuneration as (fare)+(negative profits such as gasoline due to dispatching the taxi). (iv) represents increases and decreases in taxis other than those allocated to customers. The increases and decreases in the number of taxis other than allocation to customers include drivers' arrival and departure. It is considered that maximizing the following corporate profits when repeating (i)-(iv) above n times.

$${\sum }_{i = 1}^{n} {β}^{s - 1} R ( t ) \qquad [ Equation 4 ]$$

Here, β is a parameter which determines how much to discount the future value and R(t) is the amount of reward obtained at the tth repetition. The processor 11 maximizes the reward amount by presenting an appropriate option set K⊆L and price vector

$$x := {\{ {x}_{k} \}}_{k ∈ K} \qquad [ Equation 5 ]$$

at each tth repetition. By solving the problem formulated in this way, it is possible to determine resource options and prices to be presented to each customer in a market that deals with a plurality of types of limited resources. Note that any method may be used as long as it can derive a solution to the above formulated problem.

The processing procedure when applying a reinforcement learning solution method is explained as a method which can efficiently solve the above quantified problem.

In this example, the type of resource is m and the possible values of the price vector are

$$X = [ {p}_{low} , {p}_{high} ] ∈ R . \qquad [ Equation 6 ]$$

In the following explanation, the appearing user is expressed as

$$v ∈ {\{ 0 , 1 \}}^{\vert V \vert} . \qquad [ Equation 7 ]$$

Here, V is a set of subscripts representing users who can appear.

It is assumed that the remaining amount vector of resources is

$$r ∈ {N}^{m} \qquad [ Equation 8 ]$$

and the current number of repetitions is

$$t ∈ {\{ 0 , 1 \}}^{n} . \qquad [ Equation 9 ]$$

Here, n is the maximum number of repetitions.

At this time, the state is shown by

$${s}_{t} ∈ {\{ 0 , 1 \}}^{\vert V \vert} \times {N}^{m} \times {\{ 0 , 1 \}}^{n} . \qquad [ Equation 10 ]$$

When the price vector of each resource is

$$x ∈ {X}^{m} \qquad [ Equation 11 ]$$

and the option vector is

$$o ∈ {\{ 0 , 1 \}}^{m} , \qquad [ Equation 12 ]$$

the action is shown as

$$a ∈ {X}^{m} \times {N}^{m} . \qquad [ Equation 13 ]$$

The reward when action a is taken in state Sₜ is expressed as

$$R ( {s}_{t} , a ) \qquad [ Equation 14 ]$$

and the transition probability to Sₜ₊₁ when action a is taken in state Sₜ is expressed as

$$T ( {s}_{t} , a , {s}_{t + 1} ) . \qquad [ Equation 15 ]$$

For example, a case in which the Bellman Expression

$$Q ( {s}_{t} , a ) = R ( {s}_{t} , a ) + γ {max}_{{a}^{′}} E [ Q ( {s}_{t + 1} , {a}^{′} ) ] \qquad [ Equation 16 ]$$

is applied is explained. Here,

$$R ( {s}_{t} , a ) \qquad [ Equation 17 ]$$

indicates an immediate reward and

$$γ {max}_{{a}^{′}} E [ Q ( {s}_{t + 1} , {a}^{′} ) ] \qquad [ Equation 18 ]$$

indicates a future reward. When the function Q(s, a) is approximated by a deep Q-network, the optimal strategy can be found from the following expression.

$${π}_{Q} ( s ) = {arg max}_{a ∈ 𝒜} Q ( s , a ) \qquad [ Equation 19 ]$$

Problems when applying the Bellman expression include that the number of actions is a combination of consecutive values and discrete values and that the number of possible combinations of discrete values is enormous. Thus, it is possible to improve and apply reinforcement learning with the structure of Wolpertinger Architecture. Wolpertinger Architecture is a framework for applying reinforcement learning to problems with large discrete action spaces.

The processing procedure when using the Wolpertinger Architecture improved to handle consecutive values is explained.

First, an action (consecutive value) is calculated from the state s using a (learned) mapping.

$$\hat{a} \qquad [ Equation 20 ]$$

is calculated.

$${f}_{{θ}^{π}} ; 𝒮 \to {ℝ}^{n} \qquad [ Equation 21 ]$$

$${f}_{{θ}^{π}} ( s ) = \hat{a}$$

Subsequently, k neighboring actions of the action

$$\hat{a} \qquad [ Equation 22 ]$$

are selected.

$$g : {ℝ}^{n} \to 𝒜 \qquad [ Equation 23 ]$$

$${g}_{k} ( \hat{a} ) = {arg min}_{a ∈ 𝒜}^{k} {\vert a - \hat{a} \vert}_{2}$$

In the action space A, the neighborhood is obtained only for the discrete part of the option vector. The portion of the price vector which corresponds to the continuous portion is fixed here. Here, a vector

$$\hat{a} \qquad [ Equation 24 ]$$

whose elements are all consecutive values is included in the correct action space set by taking the neighborhood of the part that corresponds to the discrete vector that corresponds to ‘′Which option should be presented?’ Subsequently, the optimal action is selected from the k actions using the (learned) mapping.

$${π}_{θ} ( s ) = {arg max}_{a ∈ {g}_{k} ∘ {f}_{{θ}^{π}} ( s )} {Q}_{{θ}^{Q}} ( s , a ) \qquad [ Equation 25 ]$$

A set of options is determined from a set of neighborhoods. Based on the method described above,

$${f}_{{θ}^{π}} \qquad [ Equation 26 ]$$

and

$${Q}_{{θ}^{Q}} \qquad [ Equation 27 ]$$

are learned. Although the known Wolpertinger Architecture limits the variables under the decision maker's control to discrete variables, the improved method includes price which is a continuous variable as a control variable. The improved method is a version of the known Wolpertinger Architecture method which can be applied to both discrete and continuous control variables.

### (Example of Server Operation)

The procedure of processing using the server 1 is explained.

Note that, in the following description using the server 1 as a main object, the server 1 may be read as the processor 11.

Note that the processing procedure which will be described below is only an example and each process may be changed as much as possible. Furthermore, with regard to the processing procedure which will be described below, steps can be omitted, replaced, or added as appropriate depending on the embodiment.

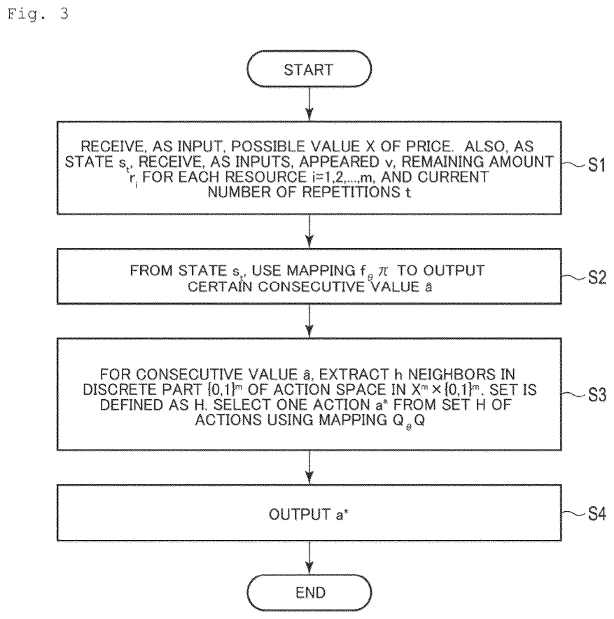

FIG. 3 is a flowchart for describing the procedure and contents of information processing performed using the server 1 according to the embodiment.

In the example which will be described below, the processor 11 determines an action at each repetition through trained reinforcement learning. Reinforcement learning can be realized, for example, by improving the known Wolpertinger Architecture which is one of the frameworks as described above.

The input part 110 receives, as the possible value X of the price and the state st, the state sₜ, the appearance v, the remaining amount rᵢ for each resource (i=1, 2, . . . , m), and the current number of repetitions t (Step S1).

The market state at (ii) shown in FIG. 2 for each repetition t is expressed as

$${{s}_{t} ∈ ( 0 , 1 \}}^{\vert V \vert} \times {N}^{m} \times {\{ 0 , 1 \}}^{n} . \qquad [ Equation 28 ]$$

At this time, sₜ is a one-hot vector representing the appearing user v∈V, a vector representing the remaining amount rᵢ (i=1, 2, . . . , m) of each resource, and a one-hot vector representing the current iteration t∈{0, 1, . . . , n}. Subsequently, it is supposed that the action decided by the user (decision maker) at each repetition t is

$${a}_{t} ∈ {X}^{m} \times {\{ 0 , 1 \}}^{m} . \qquad [ Equation 29 ]$$

At this time, at is a vector representing the price set for each resource and which options are presented.

The consecutive value determination part 111 outputs a certain consecutive value

$${f}_{{θ}^{π}} \qquad [ Equation 30 ]$$

from the state sₜ using the mapping

$$\hat{a} ∈ {X}^{m} \times {[ 0 , 1 ]}^{m} \qquad [ Equation 31 ]$$

### (Step S2).

$${f}_{{θ}^{π}} ( s ) = \hat{a} \qquad [ Equation 32 ]$$

The action determination part 112 extracts h neighbors in the discrete part ({0, 1}^{m}) of the action space

$${X}^{m} \times {\{ 0 , 1 \}}^{m} \qquad [ Equation 34 ]$$

for the consecutive value and

$$\hat{a} \qquad [ Equation 33 ]$$

selects one action a* from the extracted action set H using the mapping

$${Q}_{{θ}^{Q}} \qquad [ Equation 35 ]$$

### (Step S3).

$${a}^{*} = {Q}_{{θ}^{Q}} ( {s}_{t} , H ) \qquad [ Equation 36 ]$$

The action determination part 112 performs the process using the above a* as an appropriate action.

The output part 113 outputs a* (Step S4).

In the above example, the action is determined using the mappings

$${f}_{{θ}^{π}} \qquad [ Equation 37 ]$$

and

$${Q}_{{θ}^{Q}} . \qquad [ Equation 38 ]$$

By learning these as a neural network, they can be set as mappings which generate high corporate profits.

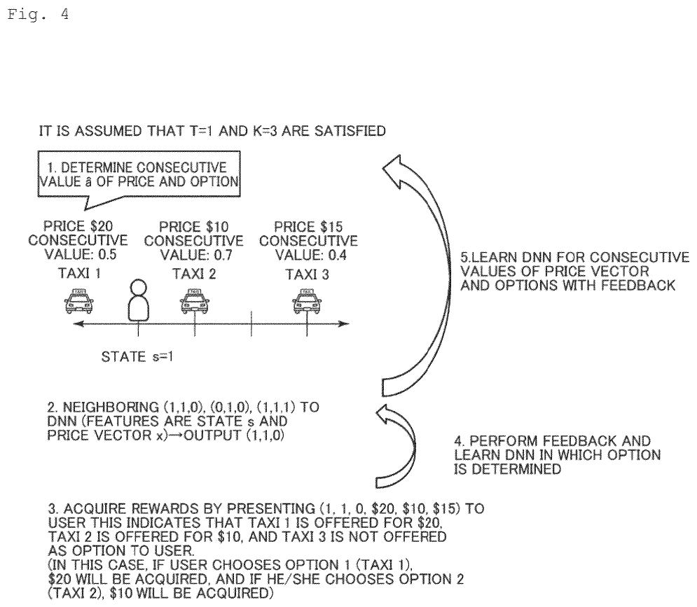

FIG. 4 is a diagram schematically showing an example of the processing contents of information processing performed using the server 1 according to the embodiment.

FIG. 4 shows the reinforcement learning process in the taxi market example.

First, it is assumed that T=1 and K=3. The consecutive value determination part 111 determines consecutive values

$$\hat{a} \qquad [ Equation 39 ]$$

of prices and options in accordance with the options.

For example, when a state s representing the number of users, the positional relationship between each user and each taxi, or the like is given to the consecutive value determination part 111, the consecutive value determination part 111 determines that the price “20 dollars” and the consecutive value of options “0.5” for Taxi 1, the price “10 dollars” and the consecutive value of options “0.7” for Taxi 2, and the price “15 dollars” and the consecutive value of the options “0.4” for Taxi 3.

Subsequently, the action determination part 112 inputs (1, 1, 0), (0, 1, 0), and (1, 1, 1) which are in the vicinity of (0.5, 0.7, 0.4) of consecutive values corresponding to the discrete part in the original action space to a deep neural network (DNN). In this case, the features are the state s and the price vector x.

The action determination part 112 selects (1, 1, 0) as the optimal action. This indicates that Taxi 1 and Taxi 2 are presented as options (the corresponding element is “1”) and Taxi 3 is not presented as an option (the corresponding element is “0”).

The output part 113 outputs an action (1, 2).

At this time, the processor 11 obtains the reward

$$R ( s , a ) \qquad [ Equation 40 ]$$

when taking an action (1, 2, $20, $10) in state s.

After that, the processor 11 performs learning by giving feedback and determining options. Furthermore, the processor 11 performs feedback and learns the consecutive values of the price vector and the options.

### Effects

As described in detail above, according to the present embodiment, it is possible to optimize resource options and prices presented to each customer in a market in which a plurality of types of limited resources are handled. According to this embodiment, since desirable options are presented to each customer and each resource is less likely to run out, corporate profits can be increased.

Although this embodiment has been described using an example assuming provision of resources and prices in the taxi market, the present invention is not limited thereto. This embodiment is also applicable to various services which provide resources and prices to customers.

The information processing apparatus may be realized using one device as described in the above example or may be realized using a plurality of devices with distributed functions.

The program may be transferred while being stored in the electronic device or may be transferred without being stored in the electronic device. In the latter case, the program may be transferred via a network or may be transferred while being recorded on a recording medium. The recording medium is a non-transitory tangible medium. The recording medium is a computer readable medium. The recording medium may be any medium capable of storing a program and readable by a computer such as a CD-ROM or a memory card and the form thereof is not limited.

Although the embodiments of the present invention have been described in detail above, the above description is merely an illustration of the present invention in all respects. It goes without saying that various improvements and modifications can be made without departing from the scope of the invention. That is to say, in implementing the present invention, specific configurations depending on the embodiments may be adopted as appropriate.

In short, the present invention is not limited to the above-described embodiments as they are, but can be implemented by modifying the constituent elements within the scope of the invention at the implementation stage. Moreover, various inventions can be formed by appropriately combining the plurality of components disclosed in the above embodiments. For example, some components may be deleted from all the components shown in the embodiments. Furthermore, components from different embodiments may be combined as appropriate.

### REFERENCE SIGNS LIST

1 Server
11 Processor
12 Main memory
13 Auxiliary storage device
14 Communication interface
100 Setting part
110 Input part
111 Consecutive value determination part
112 Action determination part
113 Output part

1. An information processing apparatus, comprising:
circuitry configured to
define a problem by formulating optimization of resource options and prices of the options to be presented to each user in a market in which a plurality of types of limited resources are handled; and
determine the resource options and the prices of the options to be presented to each user by solving the problem.

2. The information processing apparatus according to claim 1, wherein the problem is to maximize a reward for a resource provider.

3. The information processing apparatus according to claim 1, wherein the problem maximizes a total reward by repeatedly performing a process of observing users who appear from a set of a plurality users on the basis of a probability distribution, presenting a plurality of options included in a plurality of resources and the prices of the plurality of options to the appearing user, obtaining rewards for resource providers when one option is selected from the plurality of options depending on the probability distribution, reducing a remaining amount of resources of one selected option by 1, and changing the remaining amount of resources for each option depending on a value which follows the probability distribution a plurality of times.

4. The information processing apparatus according to claim 1, wherein the determining further comprises determining resource options and prices of the options to be presented to each user by reinforcement learning for the problem.

5. The information processing apparatus according to claim 3, the circuitry further configured to:
receive, as an input, a state based on a vector representing the appearing user, a vector representing the remaining amount of each resource, and a vector representing the current number of repetitions; and
determine consecutive values of options and prices using mapping from the state,
wherein the determining further comprises determining the one option as one action on the basis of the consecutive value.

6. The information processing apparatus according to claim 5, wherein the determining further comprises determining the one action for the consecutive value using mapping from a set of a predetermined number of neighbors in a discrete portion of an action space.

7. An information processing method performed using an information processing apparatus, the method comprising:
defining a problem by formulating optimization of resource options and prices of the options to be presented to each user in a market in which a plurality of types of limited resources are handled; and
determining the resource options and the prices of the options to be presented to each of the users by solving the problem.

8. A non-transitory computer readable storage medium storing an information processing program executed by an information processing apparatus to provide the steps of:
defining a problem by formulating optimization of resource options and prices of the options to be presented to each user in a market in which a plurality of types of limited resources are handled; and
determining the resource options and the prices of the options to be presented to each of the users by solving the problem.
